(19) United States
(12) Patent Application Publication
(10) Pub. No.: US 2014/0072298 A1
(43) Pub. Date: Mar. 13, 2014

(54) RADIO FREQUENCY SIGNAL TRANSCEIVING DEVICE AND METHOD THEREOF, SELF-OPTIMIZING OPTICAL TRANSMISSION DEVICE AND METHOD THEREOF

(71) Applicant: Industrial Technology Research Institute, Hsinchu (TW)

(72) Inventor: Hsin-An Hou, New Taipei City (TW)

(73) Assignee: Industrial Technology Research Institute, Hsinchu (TW)

(21) Appl. No.: 14/024,557

(22) Filed: Sep. 11, 2013

Related U.S. Application Data
(60) Provisional application No. 61/699,305, filed on Sep. 11, 2012.

(51) Int. Cl. H04B 10/11; H04B 10/077

(52) U.S. Cl. CPC H04B 10/11; H04B 10/077
USPC 398/16; 398/43

(57) ABSTRACT

A radio frequency signal transceiving method and device thereof are proposed. The method is configured for a radio equipment controller (REC) of a radio frequency signal transceiving device to exchange radio signals between a plurality of Baseband Units (BBUs) and a plurality of Radio Equipments (REs) that respectively connected to a plurality of Remote Radio Units (RRUs), and the method includes but not limited to the step of: receiving a first radio downlink signal at least, generating a first downlink control signal, modulating the first radio downlink signal at least into a first analog downlink signal at a first frequency according to the first downlink control signal, multiplexing the first analog downlink signal and the first downlink control signal into an integrated analog downlink signal, converting the integrated analog downlink signal into an optical downlink signal, and transmitting the optical downlink signal.

### CROSS-REFERENCE TO RELATED APPLICATION

This application claims the priority benefits of U.S. provisional application Ser. No. 61/699,305, filed on Sep. 11, 2012. The entirety of the above-mentioned patent applications is hereby incorporated by reference herein and made a part of this specification.

### TECHNICAL FIELD

The technical field relates to a radio frequency signal transceiving device and method thereof, and self-optimizing optical transmission device and method thereof.

### BACKGROUND

Radio interfaces such as Common Public Radio Interface (CPRI) or Open Base Station Standard Initiative (OBSAI) standardizes the protocol interface between the radio equipment control (REC) and the radio equipment (RE) in wireless base stations, which allows Baseband Units (BBUs) and Remote Radio Units (RRUs) of the base stations could be separated, so that system capacity and flexibility could be improved thereby. However, one of the main drawbacks of these protocols is the bandwidth efficiency. For example, the CPRI consumes more than 9 GHz of bandwidth to transmit/receive 24 channels of 3.84 MHz W-CDMA signaling, it would be and it could be foreseen that the spectrum would be run out when wireless communication system of the base stations evolves MIMO mechanisms or evolutes to 4G or specifications beyond 4G.

### SUMMARY

Accordingly, the radio frequency signal transceiving method would be configured for a radio equipment controller (REC) of a radio frequency signal transceiving device to exchange radio frequency signals between a plurality of Baseband Units (BBUs) and a plurality of Radio Equipments (RE) that respectively connected to a plurality of Remote Radio Units (RRUs), and the method would include but not limited to the step of: receiving a first radio downlink signal at least, generating a first downlink control signal, modulating the first radio downlink signal at least into a first analog downlink signal at a first frequency according to the first downlink control signal, multiplexing the first analog downlink signal and the first downlink control signal into an integrated analog downlink signal, converting the integrated analog downlink signal into an optical downlink signal, and transmitting the optical downlink signal.

In one of exemplary embodiments of the present disclosure, the radio frequency signal transceiving method would be configured for a Radio Equipments (RE) of a radio frequency signal transceiving device to exchange radio frequency signals between a radio equipment controller (REC) and a Remote Radio Units (RRU), wherein the REC is connected to a Baseband Units (BBU), the method would include but not limited to the step of: receiving a first optical downlink signal from the REC, converting the first optical downlink signal into a first integrated analog downlink signal, deriving a first downlink control signal from the first integrated analog downlink signal, and deriving an first analog downlink signal from the first integrated analog downlink signal according to the first downlink control signal, wherein the first analog downlink signal is at a first frequency, demodulating the first analog downlink signal into a first radio downlink signal, and transmitting the first radio downlink signal.

In one of exemplary embodiments of the present disclosure, the radio frequency signal transceiving device would include but not limited to, a radio equipment controller (REC), and a plurality of Radio Equipments (RE). The REs connected to the REC, wherein the REs comprising a first RE and a second RE at least. The REC receives a first radio downlink signal at least; generates a first downlink control signal; modulates the first radio downlink signal into a first analog downlink signal at a first frequency according to the first downlink control signal and the first frequency; multiplexes the first analog downlink signal and the first downlink control signal into a first integrated analog downlink signal; converts the first integrated analog downlink signal into an optical downlink signal; and transmits the optical downlink signal to the REs.

Accordingly, the present disclosure proposes a self-optimizing optical transmission device and a method thereof. In one of exemplary embodiments of the present disclosure, the self-optimizing optical transmission device would be configured for self-monitoring and self-adjustment and the self-optimizing optical transmission device may includes a master transmission end and a slave end. The master transmission end would include but not limited to, a vector signal generator (VSG), a master electric-to-optical converter (E/O), a master optical-to-electric converter (O/E), a vector signal analyzer (VSA) and a master control unit. The VSG would be configured to generate a testing signal. The master E/O would be coupled to the VSG, and would be configured to combine the testing signal into an integrated analog downlink signal and convert the integrated analog downlink signal into the optical downlink signal. The master O/E would be configured to receive an optical uplink signal, convert the optical uplink signal to an integrated analog uplink signal, and split the testing signal from the integrated analog uplink signal. The vector signal analyzer (VSA) would be coupled to the master O/E and would be configured to analyze the testing signal to generate a testing result, wherein the testing result comprising a error vector magnitude (EVM) value. The master control unit, coupled to the master E/O, the master O/E, the VSG and the VSA, receives the testing result, and adjusts a gain adjustment (GA) value and a driving current of the master E/O and the master O/E according to the testing result. And the slave end may include but not limited to: a slave O/E, a slave E/O, a splitter, a combiner and a slave control unit. The slave O/E would be coupled to the master E/O, would receive and convert the optical downlink signal into the integrated analog downlink signal. The slave E/O would be coupled to the slave O/E, would convert the integrated analog uplink signal into the optical uplink signal. The splitter would coupled to the slave O/E, would split the testing signal from the integrated analog downlink signal. The combiner would be coupled to the slave E/O, would combine the testing signal into the integrated analog uplink signal. And the slave control unit would be coupled to the slave O/E, the slave E/O, the splitter and the combiner, would adjust the input level and the driving current of the slave E/O and the output level and the driving current of the slave O/E by a gain adjustment (GA) value via the master control signal and a slave control signal exchanging between the master control unit and the slave control unit according to the testing result.

In one of the exemplary embodiments of the present disclosure, the self-optimizing optical transmission method would be configured for a master transmission end of an optical transmission device to self monitor and self adjustment. The self-optimizing optical transmission method would include not limited to the step of: generating a testing signal at a master end; combining the testing signal into an integrated analog downlink signal and converting the integrated analog downlink signal into the optical downlink signal at the master end, converting the optical downlink signal to the integrated analog downlink signal, deriving the testing signal from the integrated analog downlink signal, combining the testing signal into an integrated analog uplink signal, and converting the integrated analog uplink signal into an optical uplink signal at a slave end, receiving the optical uplink signal, converting the optical uplink signal to the integrated analog uplink signal, and splitting the testing signal from the integrated analog uplink signal, analyzing the testing signal to generate a testing result, wherein the testing result comprising a error vector magnitude (EVM) value, and adjusting an input level and a driving current of a plurality of E/Os and output levels and driving currents of O/Es at the master end and the slave end via generating a master control signal and a slave control signal according to the testing result.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating base station including the radio frequency signal transceiving device according to one of the exemplary embodiments.

FIG. 2A is frequency spectrum diagram of the integrated analog downlink signal according to one of the exemplary embodiments.

FIG. 2B is frequency spectrum diagram of the integrated analog downlink signal according to one of the exemplary embodiments

FIG. 3A is a schematic diagram illustrating a front end circuit of the REC according to one of the exemplary embodiments.

FIG. 3B is a schematic diagram illustrating a front end circuit of the REC according to one of the exemplary embodiments.

FIG. 4A and FIG. 4B are schematic diagrams illustrating a front end circuit of the RE according to two different of the exemplary embodiments.

FIG. 5 is a schematic diagram illustrating a self-optimizing optical transmission device according to one of the exemplary embodiments.

FIG. 6 is a flow chart illustrating the self-optimizing optical transmission method according to one of the exemplary embodiments.

FIG. 7 is a flow chart illustrating self-optimizing optical transmission method according to one of the exemplary embodiments.

FIG. 8 is a figure illustrating curves of dynamic range corresponding to different driving currents in the measured E/O and O/E.

FIG. 9 is a flow chart illustrating the self-diagnose process in the self-optimizing optical transmission method according to one of the exemplary embodiments.

FIG. 10 is a schematic diagram illustrating a self-optimizing optical transmission device according to one of the exemplary embodiments.

FIG. 11 is a flow chart illustrating radio frequency signal transceiving method according to one of the exemplary embodiments.

FIG. 12 is a flow chart illustrating radio frequency signal transceiving method according to one of the exemplary embodiments.

### DETAILED DESCRIPTION OF DISCLOSED EMBODIMENTS

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art. Therefore, The term “base station” in this disclosure could be, for instances, an evolved Node B or eNodeB, a Node-B, a base transceiver system (BTS), an access point, a home base station, a relay station, a scatterer, a repeater, an intermediate node, an intermediary, and/or satellite-based communication base stations, and so forth.

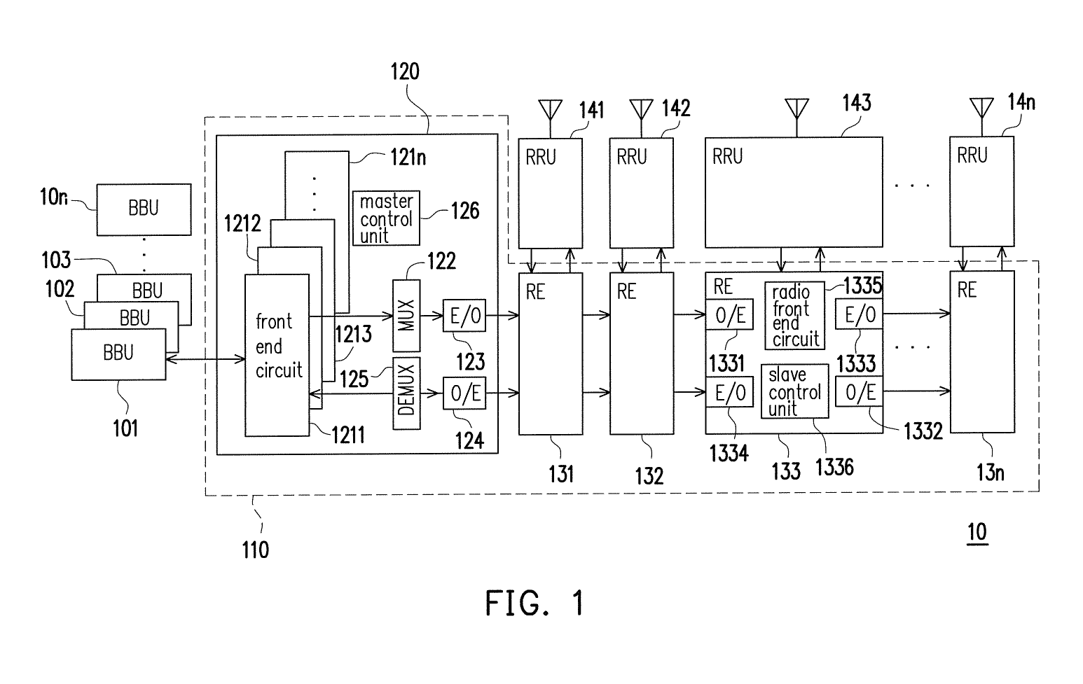

FIG. 1 is a schematic diagram illustrating base station including the radio frequency signal transceiving device according to one of the exemplary embodiments. Referring to FIG. 1, in the base station 10, the radio frequency signal transceiving device 110 could be referred as a radio frequency signal interface that would exchange radio frequency signals between the Baseband Units (BBUs) 101-10n and the Remote Radio Units (RRUs) 141-14n. In one of the exemplary embodiments, the radio frequency signal transceiving device 110 would includes but not limited to, a radio equipment controller (REC) 120 and radio equipment (RE) 131-13n. The radio frequency signals which may be exchanged in the radio frequency transceiving device 110 could be concluded as two paths, a downlink path and a uplink path. Signals that being transmitted on the downlink path and the related configurations would be described first, and then signals that being transmitted on the uplink path and the related configurations would be describe in the latter descriptions.

In the aspect of transmitting signals on the downlink path, the radio equipment controller (REC) 120 would be configured to receive radio downlink signals from the BBUs 101-10n, and the REC 120 would modulate the radio downlink signals into analog downlink signals at a plurality of specified frequency respectively. The REC 120 would also multiplex the analog downlink signals into a integrated analog downlink signal, convert the integrated analog downlink signal to an optical downlink signal and transmit the optical downlink signal through a fiber.

The RE 131-13n would be coupled to the REC 120 with the fiber, in this exemplary embodiment, the RE 131-13n are serial connected with the REC 120 by the fiber and the connecting relationship of the REC 120 and the RE 131-13n can be referred as a chain structure, but in other embodiment of the present disclosure, parts of the RE 131-13n would be connected to the REC 120 through another parts of the RE 131-13n, such that the connecting relationship between the REC 120 and the RE 131-13n could be referred as a star structure or a tree structure, the disclosure is not limited thereto.

In this exemplary embodiment, the RE 131-13n are respectively coupled to one of the RRU (of RRU 141-14n), and also correspond to one of BBU101-10n respectively. For example, the RE 131 would be coupled to RRU141, and may correspond to the BBU 101, and the RE 132 would be coupled to the RRU 142, and may correspond to the BBU 102.

In this exemplary embodiment, the RE 131-13n would be configured to receive the optical downlink signal from the REC 120, respectively convert the optical downlink signal to derive the radio downlink signals of the corresponding BBU (e.g., one of BBU 101-10n), and transmit the radio downlink signal to the corresponding RRU (e.g., RE 131 (the first RE) may derive the radio downlink signal corresponding to BBU 101 (the first BBU) and transmit the downlink radio signal to the RRU 141 (the first RRU of the RRUs).

In this exemplary embodiment, the REC 120 would include but not limit to front end circuits 1211-121n, a multiplexer (MUX) 122, a REC electric to optical converter (E/O) 123, a REC optical to electric converter (O/E) 124, a de-multiplexer (DEMUX) 125 and a master control unit 126, wherein the front end circuits 1211-121n, a multiplexer (MUX) 122, a REC electric to optical converter (E/O) 123 and the master control unit 126 would be configured to use in the downlink path.

The master control unit 126 would be coupled to the front end circuit 1211-121n and the MUX 122. The master control unit 126 would assign the frequency value of the specified frequencies to each of the front end circuit 1211-121n, so that the front end circuit 1211-121n could respectively modulate the radio downlink signals into the analog downlink signals at specified frequencies. Also, the master control unit 126 would generate downlink control signals according to the frequency value of the specified frequencies respectively, and transmit downlink control signals to the MUX 122. When the MUX 122 receives the downlink control signals, the MUX 122 multiplexes the downlink control signals together with the analog downlink signals into the integrated analog downlink signal.

In this exemplary embodiment, front end circuits 1211-121n would be coupled to the BBUs 101-10n respectively, and would be configured to receive radio downlink signals from the corresponding BBUs 101-10n and modulate the radio downlink signals into analog downlink signals at specified frequencies according to the downlink control signal, respectively. The MUX 122 would be coupled to the front end circuit 1211-121n, and would multiplex the analog downlink signals into an integrated analog downlink signal. In this exemplary embodiment, the MUX 122 would multiplex the analog downlink signals into the integrated analog downlink signal by frequency division multiplexing (FDM), time division multiplexing (TDM), frequency division multiplexing for both time division duplex (TDD) and frequency division duplex (FDD), or wavelength division multiplexing for bi-direction multiplexing (both signals on downlink path and uplink path), but the disclosure is not limited thereto.

The REC E/O 123 would be coupled to the MUX 122 and the RE 131-13n (e.g., through the fiber connected to the RE 131-13n), and REC E/O 123 would convert the integrated analog downlink signal into the optical downlink signal, and transmits the optical downlink signal to the RE 131-13n.

On the other hand, the RE 131-13n could be identical to each other. Take the RE 133 as an example, the RE 133 would include but not limit to, O/E 1331-1332, E/O 1333-1334, radio front end circuit 1335 and slave control unit 1336. The O/E would be coupled to the REC E/O 123 (e.g., through the fiber and other REs, such as RE 131-132), and the O/E 1331 would receive the optical downlink signal and would convert the optical downlink signal into the integrated analog downlink signal. The radio front end circuit 1335 would be coupled to the O/E 1331 and the RRU 143, and would derive the analog downlink signal (which may correspond to the front end circuit 1213 of the REC 120) from the integrated analog downlink signal. And radio front end circuit 1335 may demodulate the analog downlink signal into the radio downlink signal (which may correspond to the BBU 103), and transmit the radio downlink signal to the RRU 143. On the other hand, the radio front end circuit 1335 may also receive a radio uplink signal from the RRU 143, modulates the radio uplink signal into an analog uplink signal at the first frequency, and generates a uplink control signal responding to the downlink control signal and the analog uplink signal. And then, the radio front end circuit 1335 may also receive an integrated analog uplink signal from the O/E 1332 (which may be converted from an optical uplink signal by the O/E 1332). The radio front end circuit 1335 would multiplex the analog uplink signal, the uplink control signal and the integrated analog signal into another integrated analog uplink signal (the combined integrated analog uplink signal). And then the E/O 1334 could convert the combined integrated analog uplink signal into the optical uplink signal, and transmit the optical uplink signal to REC 120 through other REs (e.g., RE 131 and 132).

The slave control unit 1336 may be coupled to the radio front end circuit 1335, and may extracts the downlink control signal corresponding to the front end circuit 1213 of the REC 120 from the integrated analog downlink signal. The slave control unit 1336 may generate a control message according to the downlink control signal extracted from the integrated analog downlink signal, and transmit the control message to the radio front end circuit 1335. Herein, the control message may include but not limited to the specified frequency of the analog downlink signal corresponding to the front end circuit 1213 of the REC 120, so that according to the first control message, the radio front end circuit 1335 could derive the analog downlink signal corresponding to the front end circuit 1213 of the REC 120 from integrated analog downlink signal.

It is noted that the downlink control signals generated by the master control unit 126 may include other information for the slave control unit 1336 to apply. For example, the slave control unit 1336 may also generate a uplink control signal in response to the downlink control signal and transmit the uplink control signal back to the master control unit 126 (e.g., may combine with the integrated analog uplink signals, which will be described in the latter disclosure), a round trip delay between the REC 120 and the RE 132 could be estimated and a link gain of the integrated analog downlink signal, a dynamic range of the input level of optical downlink signal, and other coefficient could be adjusted through the exchanging of downlink control signal and uplink control signal between the master control unit 126 and the slave control unit (e.g., salve control unit 1336), so that a signal synchronization, and a gain recovering could be accomplished by the slave control unit 1335 and a link performance could be changed thereby.

Furthermore, In this exemplary embodiment, the E/O 1333 would be coupled to the radio front end circuit 1335 and the slave control unit 1336, and would receive the integrated analog downlink signal and convert the integrated analog downlink signal into the optical downlink signal again, so that the optical downlink signal could be transmitted to the rest of the REs (for example, the RE 13n). In addition, the slave control unit 1336 may also control radio front end circuit 1335 to recover a magnitude loss according to the link gain estimated from the corresponding downlink control signal extracted from the integrated analog downlink signal before transmitting to the E/O 1333.

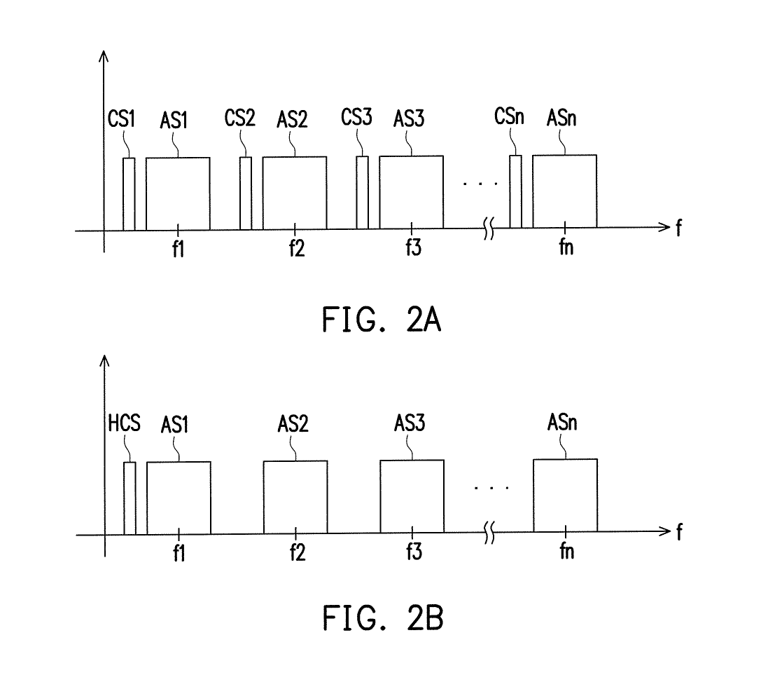

FIG. 2A is frequency spectrum diagram of the integrated analog downlink signal according to one of the exemplary embodiments. Referring to FIG. 1 and FIG. 2A, in this exemplary embodiment, the integrated analog downlink signal may include but not limit to analog downlink signal AS1-ASn and the downlink control signal CS1-CSn, as shown in FIG. 2A. The front end circuit 1211 may receive a first radio downlink signal from the BBU 101, and modulate the radio downlink signal into a first analog downlink signal AS1 at a first frequency f1 (one of the specified frequencies assigned by the master control unit 126), and so on, the nth front end circuit 121n may also receive a nth radio downlink signal from the BBU 101, and modulate the nth radio downlink signal into a nth analog downlink signal ASn at a nth frequency fn. As shown in FIG. 2A, the specified frequencies f1-fn where the analog downlink signal AS1-ASn located would be away from each other in a certain distance, so that the analog downlink signal AS1-ASn would not be overlapped or interfered by each other.

Also, the master control unit 126 respectively generates downlink control signals CS1-CSn with central frequencies (or could be referred as the control frequencies) near the corresponding analog downlink signal, for example, the downlink control signal CS1 would be nearing the analog downlink signal AS1, the downlink control signal CS2 would be nearing the analog downlink signal AS2, etc., but the disclosure is not limited the placements of the downlink control signals CS1-CSn on the frequency spectrum or the implementation type of the downlink control signals CS1-CSn.

FIG. 2B is frequency spectrum diagram of the integrated analog downlink signal according to one of the exemplary embodiments. Compare to the exemplary embodiment shown in FIG. 2A, the master control unit 126 in the exemplary embodiment shown in FIG. 2B further integrates the downlink control signals CS1-CSn into one hybrid control signal HCS before transmitting to MUX 122 to be combined into the integrated analog downlink signal. As shown in FIG. 2B, the hybrid control signal HCS can be placed at a certain frequency (the control frequency) that away from the analog downlink signals AS1-AS (for example, an out-of-band frequency), so as to reduce the bandwidth usage and the possibilities of interfering the analog downlink signals AS1-ASn. However, in this exemplary embodiment, the hybrid control signal HCS may needs to generate in a certain format, or the radio frequency transceiving device 110 may evolves a certain communication protocols between the REC 120 and the RE 131-13n, so that the REs 131-13n could recognize the content of the hybrid control signal HCS and extract the corresponding content from the hybrid control signal HCS at the control frequency. It is noted that the frequency spectrum of the analog uplink signals and the uplink control signals could be the same with the analog downlink signals and the downlink control signals in the exemplary embodiment shown in FIG. 2A or FIG. 2B. However, in some embodiment of this disclosure, the frequency spectrum of the analog uplink signals and the uplink control signals could be the different from the frequency spectrum of the analog downlink signals and the downlink control signals in the same transceiving device, the disclosure is not limited to the above arrangement.

Referring to FIG. 1, in the aspect of transmitting signals on the uplink path, the radio front end circuit of the RE 1331 may receive a radio uplink signal from the RRU 143, the radio front end circuit 1335 may modulate the radio uplink signal into an analog uplink signal at the specified frequency same with the analog downlink signal, Also, the slave control unit 1336 would generate the uplink control signal in response to the downlink control signal, wherein the uplink control signal may be located at the frequency same with the downlink control signal, and may include information such as the frequency of the analog uplink signal, the link gain, time stamps for estimating the single trip delay, and the link performance . . . etc. Meanwhile, the O/E 1332 of the RE 133 may receive an optical uplink signal from other RE (such as the RE 13n), and the O/E 1332 may convert the optical uplink signal into an integrated analog uplink signal, wherein the integrated analog uplink signal may include other analog uplink signal at specified frequencies and other uplink control signals from some of the REs (e.g., the RE 134-13n). A combiner (not shown) of the RE 133 that may be coupled to the O/E 1332, the E/O 1334 and the radio front end circuit 1335, would combine the analog uplink signal and the uplink control signal into the integrated uplink signal, and transmit the integrated uplink signal to the E/O 1334. The E/O 1334 would be coupled the combiner and the REC O/E 124 through the fiber, and the E/O 1334 would convert the integrated analog uplink signal into the optical uplink signal, and transmit the optical uplink signal to the REC O/E 124.

The REC O/E 124 that would be coupled to the fiber that connected to the RE 131-13n, would receive the optical uplink signal through the fiber, and the REC O/E 124 would convert the optical uplink signal into an integrated analog uplink signal. The de-multiplexer (DEMUX) 125 would be coupled to the REC O/E and the front end circuit 1211-121n, and would de-multiplex the integrated analog uplink signal into analog uplink signals at specified frequencies corresponding to the RE 131-13n and uplink control signals corresponding to the analog uplink signals respectively. The DEMUX 125 would transmit the uplink control signals to the master control unit 126, and the master control unit 126 would control the DEMUX 125 to transmit the analog uplink signals to the corresponding front end circuit 1211-121n respectively, but basically, since the specified frequencies would be the same with the analog downlink signals that corresponds to the same RE 131-13n (or the front end circuit 1211-121n), the DEMUX 125 could respectively transmits the analog uplink signals to the corresponding front end circuit 1211-121n. When the front end circuit 1211-121n respectively receive the corresponding analog uplink signal, front end circuit 1211-121n may respectively demodulate the analog uplink signals into radio uplink signals and transmit the first radio uplink signals to the corresponding (or coupled) BBU 101-10n.

It is noted that the specified frequencies (also called “the control frequencies” in the disclosure) in this exemplary embodiment may be assigned at an intermediate frequency (IF). The radio downlink signals and the radio uplink signals that being transmitted between the BBUs 101-10n and the front end circuit 1211-121n of the REC 120 (and between the RE 131-13n and the RRU 141-14n) could be a radio frequency signal (for example, with central frequency of 2.5 GHz or 5 GHz), a radio frequency signal with In-phase path signal and Quadrature path signal (IQ signal), an intermediate frequency signal, . . . etc. Also, in different embodiments of the disclosure, the radio downlink signals and the radio uplink signal could be digital signals or analog signals, and configurations of front end circuit 1211-121n and radio front end circuit (such as radio front end circuit 1335 of the RE 133) would be different in response to whether the radio downlink signals and the radio uplink signal are digital signals or analog signals.

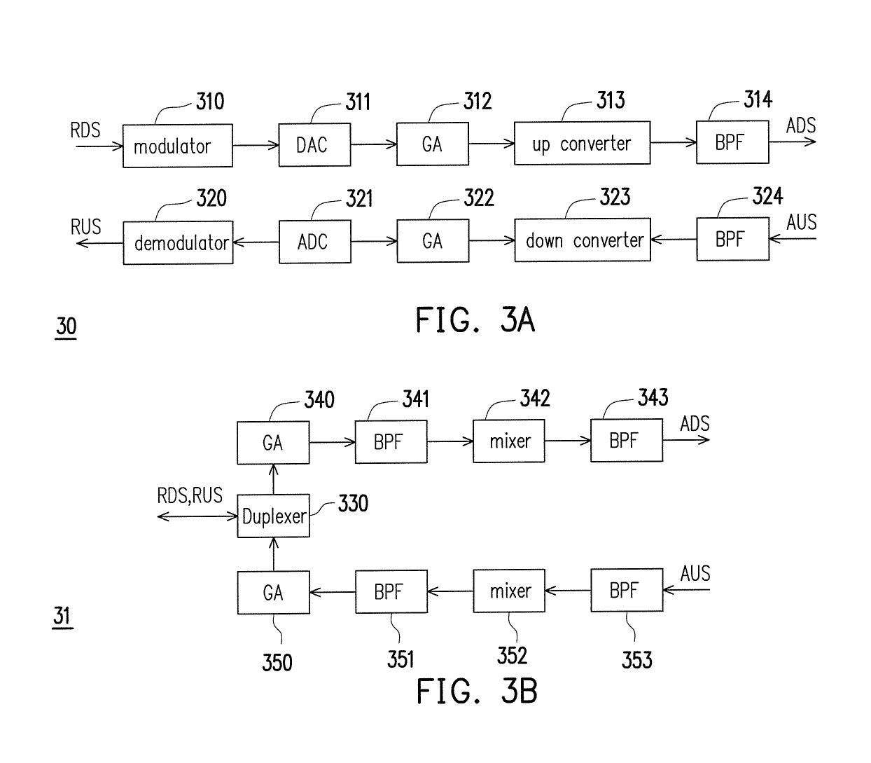

FIG. 3A is a schematic diagram illustrating a front end circuit of the REC according to one of the exemplary embodiments. Referring to FIG. 3A, in this exemplary embodiment, the radio downlink signal (RDS) and the radio uplink signal (RUS) are digital signals. The front end circuit 30 may include but not limited to modulator 310, de-modulator 320, Digital-to-Analog Converter (DAC) 311, Analog-to-Digital Converter (ADC) 321, Gain Adjustment unit (GA) 312 and 322, up converter 313, down converter 323, and bandpass filter (BPF) 314 and 324.

In the downlink path, the modulator may receive and modulate the radio downlink signal RDS into a baseband digital signal. The DAC 311 may receive the baseband digital signals from the modulator 310, and convert the baseband digital signal into baseband analog signal. Through a gain adjustment by the GA 312, the up converter 313 may receive and up-convert the baseband analog signal into the analog downlink signal ADS at the specified frequency (which is a intermediate frequency in this exemplary embodiment), and transmit the analog downlink signal ADS through the BPF 314.

In the uplink path, the down converter 323 may receive the analog uplink signal AUS through BPF 324, and down convert the analog uplink signal AUS into baseband analog signal. Through the gain adjustment by the GA 322, the ADC 321, may receive the baseband analog signal and convert the baseband analog signal into baseband digital signal. And then the demodulator 320 would receives and demodulates the baseband digital signal into radio uplink signal.

FIG. 3B is a schematic diagram illustrating a front end circuit of the REC according to one of the exemplary embodiments. The radio downlink signal and the radio uplink signal are analog signals in the exemplary embodiment shown in FIG. 3B. As a result, comparing to the exemplary embodiment shown in FIG. 3A, the ADC and DAC is omitted, the front end circuit 31 could simply down convert the radio downlink signal (or up convert the analog uplink signal) into the analog downlink signal ADS (or the radio uplink signal RUS) by the mixer 342 (or mixer 352).

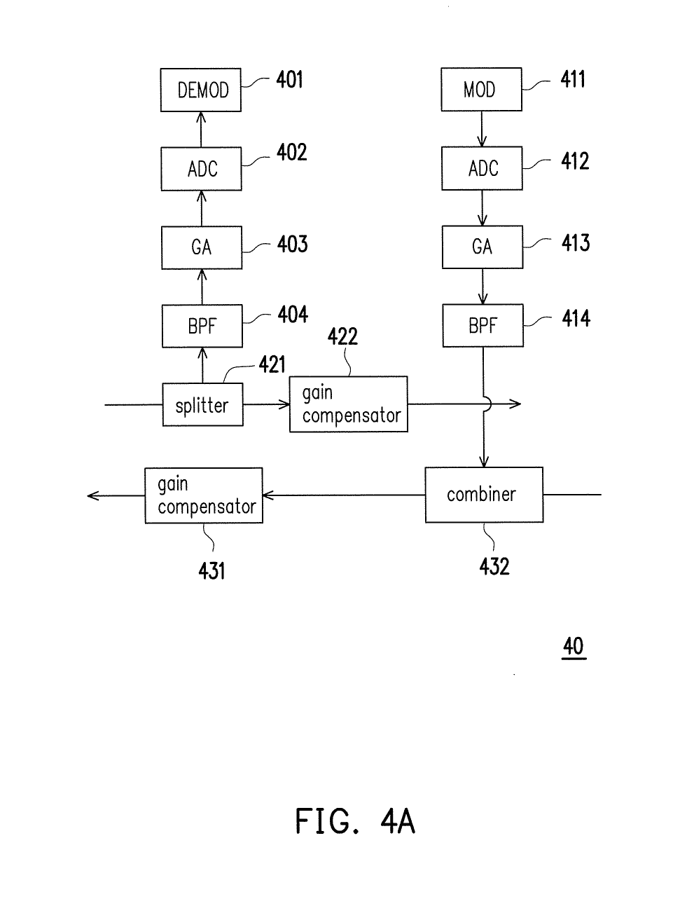

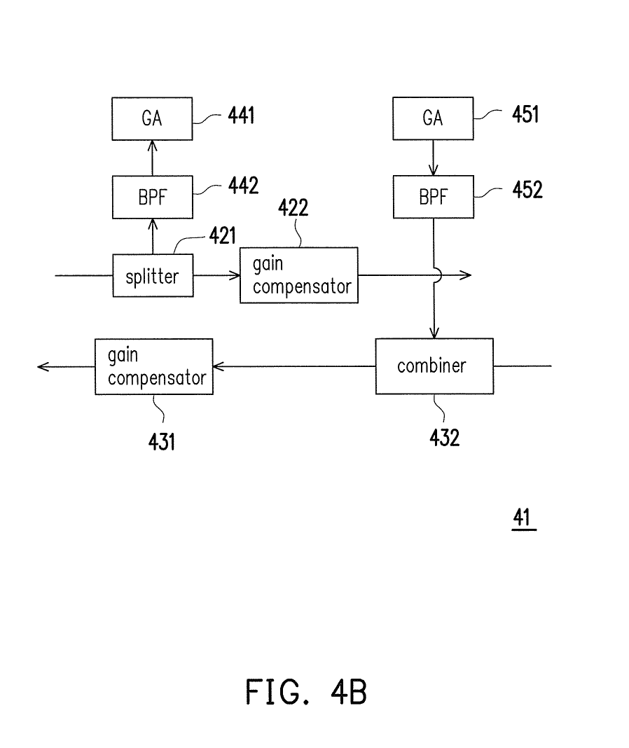

FIG. 4A and FIG. 4B are schematic diagrams illustrating a radio front end circuit of the RE according to two different of the exemplary embodiments. Same with the exemplary embodiment shown in FIGS. 3A and 3B, the radio downlink signal and radio uplink signal are digital signals in exemplary embodiment shown in FIG. 4A, and the radio downlink signal and radio uplink signal are analog signals in exemplary embodiment shown in FIG. 4B. Referring to FIGS. 4A and 4B, the different between exemplary embodiments shown in FIGS. 4A and 4B is, a ADC 402 and a DAC 412 are configured in the exemplary embodiment shown in FIG. 4A. it is noted that in exemplary embodiment shown in FIG. 4B, the radio downlink signal (and the radio uplink signal) may be down converted (up converted) in the RRU that connected to the RE. And, in these two exemplary embodiments, the splitter 421 splits out the analog downlink signal from the integrated downlink signal, and the combiner 432 combines the analog uplink signal into the integrated uplink signal.

In this exemplary embodiment, the splitting made by the splitter 421 and the combining made by the combiner 432 could be implemented by a signal switching or a signal coupling mechanism. And it is noted that, the integrated analog downlink signal after the splitting made by the splitter 421 could be the same integrated analog downlink signal, or an alternative integrated analog downlink signal different from the original integrated analog downlink signal. For example, the integrated analog downlink signal after the splitting made by the front end circuit of the first RE (e.g., the RE 131 in FIG. 1) may only include the signal components of analog downlink signals corresponding to the rest of the RE (e.g., RE 132-13n) excluding the signal component of the first analog downlink signal that being split out in the first RE (e.g., the RE 131 in FIG. 1), and the same circumstances could be applied to the rest of the REs, but the disclosure is not limited thereto.

Furthermore, since magnitudes of analog signals degrades easily during transmission, gain compensator 422 and 431 may be configured to compensate the integrated analog downlink signal after the analog downlink signal is spited out and integrated uplink signal after the analog uplink signal is combined.

It is noted that, even though the RE 131-13n would be identical to each other, some of the RE 131-13n would be slightly different owing to the configurations of the REs in the transceiving device 120. Take the RE 13n as an example, since RE 13n is at the end of the structure of RE 131-13n, E/Os and O/Es for continuing transmitting/receiving the optical signals (optical downlink/uplink signal) to/from the next RE could be omitted. In this circumstances, the gain compensator of the downlink path in the RE 13n (e.g., the gain compensator shown in FIG. 4A-4B) could be omitted. Also, due to the same reason, the combiner and the gain compensator of the uplink path (e.g., the combiner 432 and the gain compensator 431 shown in FIG. 4A-4B) in the RE 13n could also be omitted too. The radio front end circuit in the RE 13n could simply modulate the radio uplink signal received from RRU 14n into analog uplink signal, multiplex the analog uplink signal and the uplink control signal (which may be received from the slave control unit of RE 13n) into integrated analog uplink signal, and transmit the integrated analog uplink signal to the previous RE (e.g., RE 13(n−1)).

In one of the exemplary embodiment of the present disclosure, an error vector magnitude (EVM) value over the optical transmission (for example, from the REC E/O 123 to one of the O/E of RE, and from one of the E/O to the REC O/E 124) could be monitoring and the transmission quality could be adjusted immediately in response to the changes of EVM value.

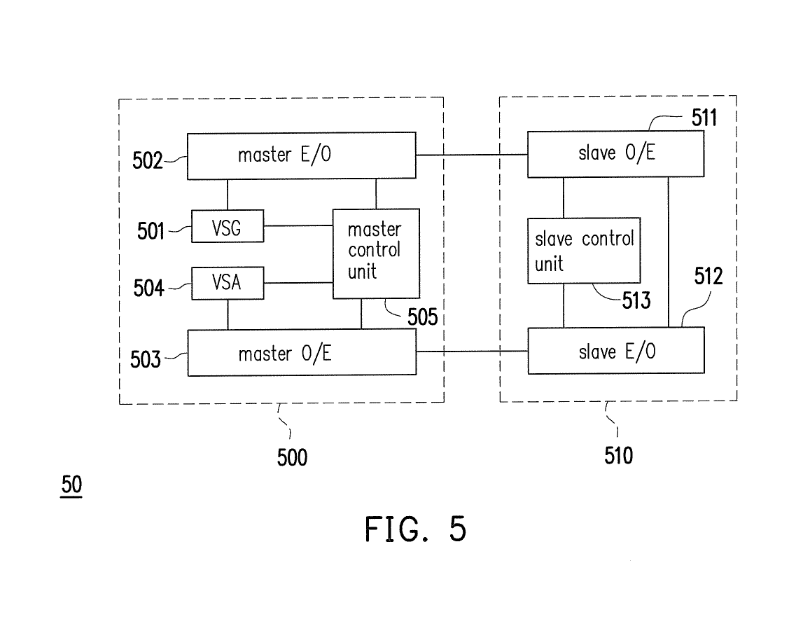

FIG. 5 is a schematic diagram illustrating a self-optimizing optical transmission device according to one of the exemplary embodiments. The self-optimizing optical transmission device may be configured for self-monitoring and self-adjustment of optical transmission, and could be integrated into the radio frequency signal transceiving device 110 in the exemplary embodiment shown in FIG. 1. Referring to FIG. 5, the self-optimizing optical transmission device 50 may include a master transmission end 500 and a slave transmission end 510, wherein the master transmission end could be integrated with the REC 120 shown in FIG. 1 and the slave transmission end could be integrated with any of the RE 131-13n.

Herein, the master transmission end 500 may include but not limit to, a vector signal generator 501, a master E/O 502 (can be referred as the master E/O 123 in FIG. 1), a master O/E 503 (can be referred as the master O/E 124 in FIG. 1), a vector signal analyzer (VSA) 504 and a master control unit 505 (can be referred as the master control unit 126 in FIG. 1). The slave transmission end 510 may include but not limit to, a slave O/E 511 (can be referred as the O/E 1331 of the RE 133 in FIG. 1), a slave E/O 512 (can be referred as the E/O 1334 of the RE 133 in FIG. 1) and a slave control unit 513 (can be referred as the slave control unit 1336 of the RE 133 in FIG. 1).

The VSG 501 may controlled by the master control unit 505, and may generate a testing signal (or a plurality of testing signal at different time frames). The master E/O 502 would be coupled to the VSG 501, and would combine the testing signal into an integrated analog downlink signal (which could be received from the MUX 122 in FIG. 1) and convert the integrated analog downlink signal into the optical downlink signal.

The slave O/E 511 would be coupled to the master E/O 502 through a fiber, and would receive and convert the optical downlink signal into the integrated analog downlink signal. The slave O/E 511 would then split the testing signal from the integrated analog downlink signal. The slave E/O 512 would be coupled to the slave O/E 511 and would combine the testing signal into an integrated analog uplink signal (which may receive from the O/E 1332 of the same RE 133), and the slave E/O 512 would convert the integrated analog uplink signal into the optical uplink signal. In this exemplary embodiment, the slave E/O 512 would combine the testing signal into an integrated analog uplink signal by switching or coupling, but the invention is not limited thereto.

The master O/E 503 would receives the optical uplink signal through the fiber, and would convert the optical uplink signal to the integrated analog uplink signal, and split the testing signal from the integrated analog uplink signal. The VSA 504 would be coupled to the master O/E 503, and would analyze the testing signal to generate a testing result, wherein the testing result comprising a error vector magnitude (EVM) value, which the EVM value corresponds to a connection quality between the master transmission end 500 and the slave transmission end.

The master control unit 505 would be coupled to the master E/O 502, the master O/E 503, the VSG 501 and the VSA 504. The master control unit 505 would receive the testing result, and adjust a gain adjustment (GA) value and a driving current (which may correspond to the input current bias) of the master E/O 502, the master O/E 503, the slave O/E 511 and the slave E/O 512 via generating a master control signal and slave control signal according to the testing result. Herein, the GA value corresponds to the input level of the master E/O 502 and slave E/O 512, and also the output level of the master O/E 503 and the slave O/E 511.

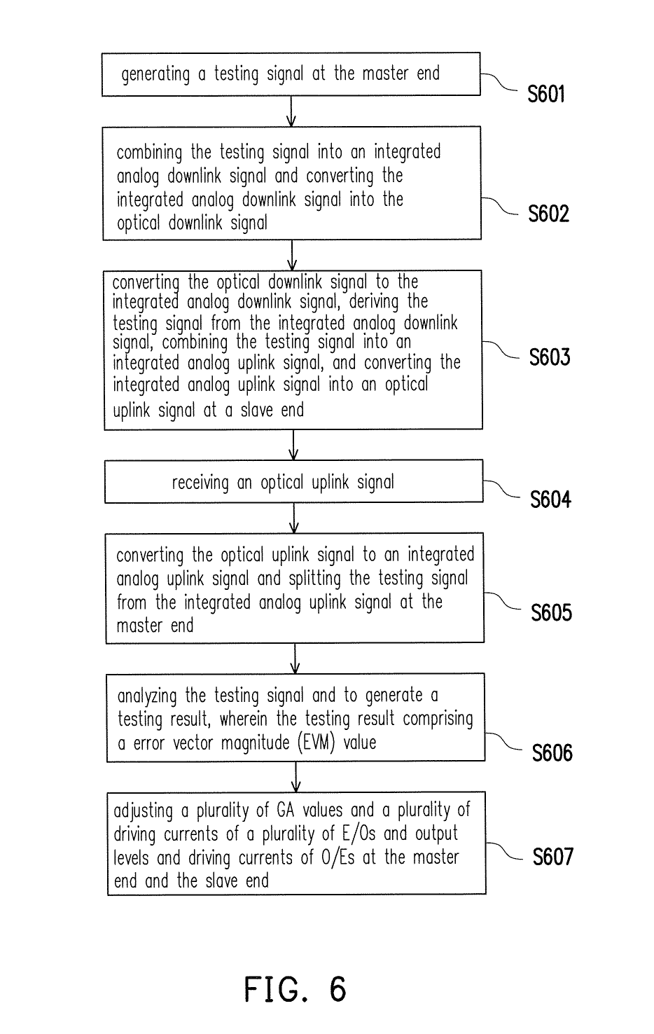

The present disclosure also provides a self-optimizing optical transmission method, wherein the method would be configured for a master transmission end of an optical transmission device to self monitor and self adjustment. FIG. 6 is a flow chart illustrating the self-optimizing optical transmission method according to one of the exemplary embodiments. Referring to FIG. 6, the self-optimizing optical transmission method would include not limited to the following steps: First, at step S601, generating a testing signal at the master end; then, at step S602, combining the testing signal into an integrated analog downlink signal and converting the integrated analog downlink signal into the optical downlink signal; then, at step S603, converting the optical downlink signal to the integrated analog downlink signal, deriving the testing signal from the integrated analog downlink signal, combining the testing signal into an integrated analog uplink signal, and converting the integrated analog uplink signal into an optical uplink signal at a slave end; also at step S604, receiving an optical uplink signal; at step S605, converting the optical uplink signal to an integrated analog uplink signal and splitting the testing signal from the integrated analog uplink signal at the master end; then at step S606, analyzing the testing signal to generate a testing result, wherein the testing result comprising a error vector magnitude (EVM) value; and then at step S607, adjusting a plurality GA values and a driving current of a plurality of E/Os and output levels and driving currents of O/Es at the master end and the slave end. The GA value corresponds to the input level of the E/Os at both the master end and the slave end, and also the output level O/Es at both the master end and the slave end. Herein, the master control signal and the slave control signal could be combined or integrated in the downlink control signal or the uplink control signal.

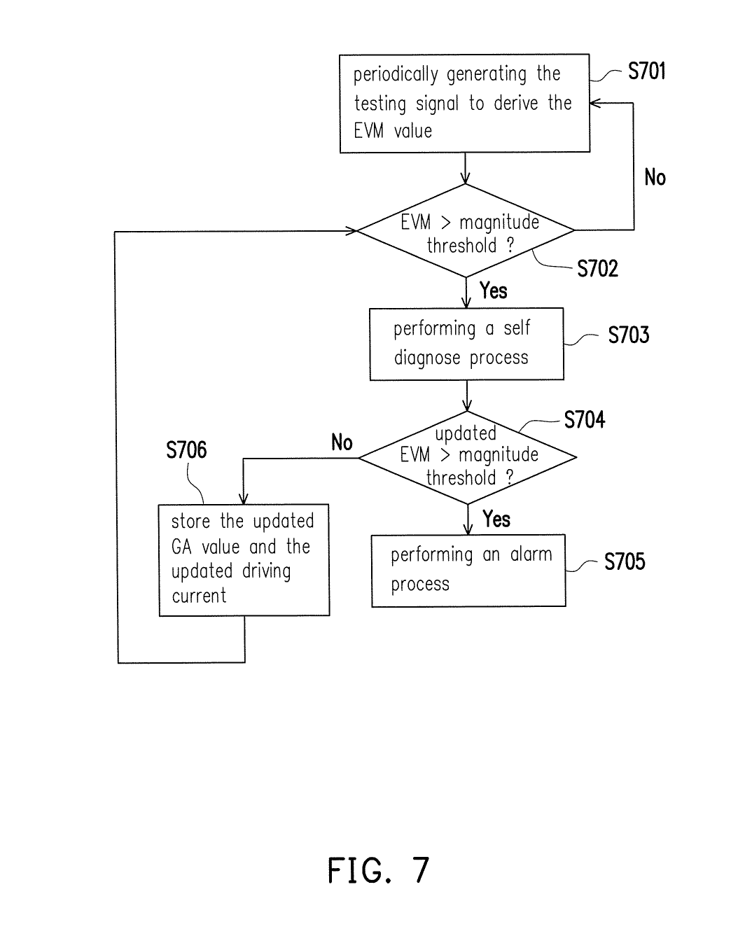

FIG. 7 is a flow chart illustrating self-optimizing optical transmission method according to one of the exemplary embodiments, which may provide a detailed implementation of the self-optimizing optical transmission method. Referring to FIG. 5 and FIG. 7, first of all, at step S701, the master control unit 505 may control the VSG 501 to generate the testing signal periodically, in order to derive the EVM value from the testing result. At step S702, the master control unit 505 may determine whether the EVM value is bigger than a magnitude threshold every time the EVM is derived. When the EVM value is smaller than the magnitude threshold, it may represent that the current connection quality may fair enough to transmit the optical signals (such as the optical downlink signal and the optical uplink signal) without any error or interference, the master control unit 505 may keep on monitoring the changes in EVM value by periodically controlling the VSG 501 to generate the testing signal (step S 701).

When the EVM value is bigger than a magnitude threshold (step S702, Yes), the master control unit 505 may perform a self-diagnose process to generate an updated GA value, an updated driving current and the updated EVM value (step S703). And the master control unit 505 may once again determine whether the EVM value is bigger than a magnitude threshold or not (step S704).

If the updated EVM value is smaller than the magnitude threshold (step S704, NO), it may represent that the adjustment made in the self-diagnose process would be proper enough to transmit the optical signals without error or interference, the master control unit 505 may store the updated GA value and the updated driving current (step S706), and the master control unit 505 may adjust the gain adjustment (GA) value and the driving current of the master E/O 502 and the master O/E 503, and would further generate a slave control signal according to the updated GA value and the updated driving current to the slave control unit 513, so that the slave control unit 513 may adjust the gain adjustment (GA) value and the driving current of the slave O/E 511 and the slave E/O 512.

And if the updated EVM value is bigger than the magnitude threshold (step 704, Yes), the master control unit 505 perform an alarm process to notify an user or an administrator of the self-optimizing optical transmission device 50 that according to the current connection quality, the optical signals would be interrupted by error or interference during the optical transmission (step S705).

In practice, the selection of driving current may directly influence the selection of GA value and the corresponding EVM value. So by executing the self-diagnose process, the driving current with the widest operating signal strength range (i.e., the dynamic range, the interval of an EVM curve corresponds the driving current that is below a preset value of EVM value, e.g., the magnitude threshold in FIG. 7) and the corresponding GA values (also the input/output levels of the E/Os and O/Es) could be derived.

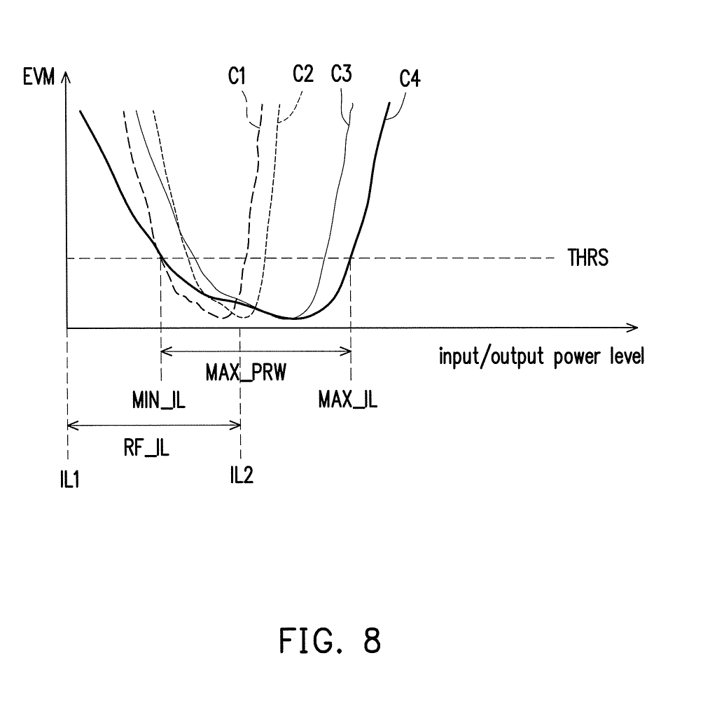

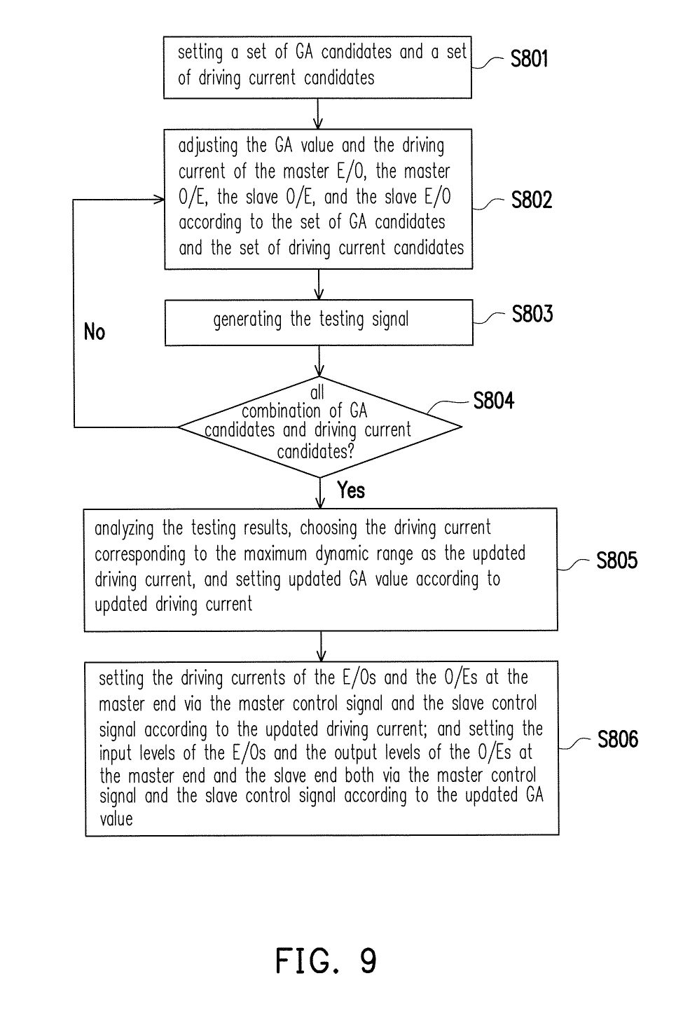

FIG. 8 is a figure illustrating relationships of dynamic range corresponding to different driving currents in the measured E/O and O/E in a single way embodiment. In a similar style, the same method could be applied in a round way embodiment when the VSG 501 and VSA 504 are at the same end. Referring to FIG. 8, the relationships of EVM value and the input/output levels of the signals (e.g., the input/output levels of the integrated analog downlink/uplink signals) that corresponds to different driving currents could be expressed as the curves C1-C4 illustrated in FIG. 8. For example, in this exemplary embodiment, curves C1-C4 respectively corresponds to (driving current of E/O, driving current of O/E) of (2 mA, 3 mA), (1 mA, 2 mA), (3 mA, 2 mA) and (2 mA, 2 mA). As defined in the described above, the maximum dynamic range would be the one of the curves C1-C4 with the maximum interval under the preset threshold THRS, e.g. 4%, so as illustrated in the FIG. 9, the curve that corresponds to the maximum dynamic range (MAX_DRW) with the minimum input level MIN IL and the maximum input level MAX_IL would be curve C4. As a result, in this exemplary embodiment, the driving current candidate that corresponds to curve C4 (i.e., (driving current of E/O, driving current of O/E) equals to (2 mA, 2 mA)) could be chosen as the updated driving current.

Once the updated driving current is chosen, the updated GA value that corresponds to the updated driving current could be determined too. For example, the input/output electric signal may have a power level range RFIL as illustrated in FIG. 8 (i.e., the input/output level of the electric signals may varies from input level IL1 to input level IL2) that would be lower (or higher) than the maximum dynamic range corresponding to the updated driving current. The master control unit may adjust the input levels with the GA candidates to shift the current power level range RF_IL to be overlapped with the maximum dynamic range MAX_DRW (or be more precise, adjusts the input/output level so that the minimum input level IL1 and maximum input level IL2 of the input/output electric signal could be included in the maximum dynamic range MAX_DRW). Once the master control unit adjusts the input/output level with one of the GA candidates that shifts the power level range RF_IL to be overlapped with the maximum dynamic range MAX_DRW, the master control unit would then set the GA candidate as the updated GA value.

FIG. 9 is a flow chart illustrating the self-diagnose process in the self-optimizing optical transmission method according to one of the exemplary embodiments. Referring to FIG. 9, at step S801, the master control unit 505 may set a set of GA candidates and a set of the driving current candidates, wherein the GA candidates would be a set of preset value of GA value, and the set of the driving current candidates would be a set of preset value of the driving current candidates. At step S802, the master control unit 505 may respectively adjust the driving current of the master E/O 502, the master O/E 503, the slave O/E 511 and the slave E/O 512 (transmits the slave control signal with the set GA value and set driving current) according to the set of the driving current candidates, and then adjust the input levels of the master E/O 502, and the slave E/O 512, and the output levels of the master O/E 503 and the slave O/E 511 according to the set of GA candidates via the master control signal and the slave control signal when adjusting the driving current. And at step S803, the master control unit 505 would control the VSG 501 to generate the testing signal every time the master control unit adjusts the GA values and the driving currents of the master E/O 502, the master O/E 503, the slave O/E 511 and the slave E/O 512.

When the testing signals corresponding to all the combinations of GA candidates and driving current candidates are received by the VSA 504, and all the testing results corresponding to these testing signals are transmitted to the master control unit 505 (step S804, Yes), the master control unit 505 may analyze the testing results of the testing signals corresponding to all combination of the GA candidates and driving current candidates, and the master control unit 505 would choose a driving current candidate that corresponds to the maximum dynamic range, and would set this driving current candidate as the updated driving current. Since the chosen dynamic range includes a maximum input level and a minimum input level of the EVM value less than the threshold for the chosen driving current, an updated GA value could also be set so that the input/output level of the optical downlink/uplink signal could be adjusted to meet the chosen dynamic range (which is the maximum dynamic range estimated by the above processes) (step S805), so that the master control unit 505 could store the updated GA value and the updated driving current and could control the master E/O, the master O/E, the slave O/E and the slave E/O according to updated GA value and the updated driving current (step S806).

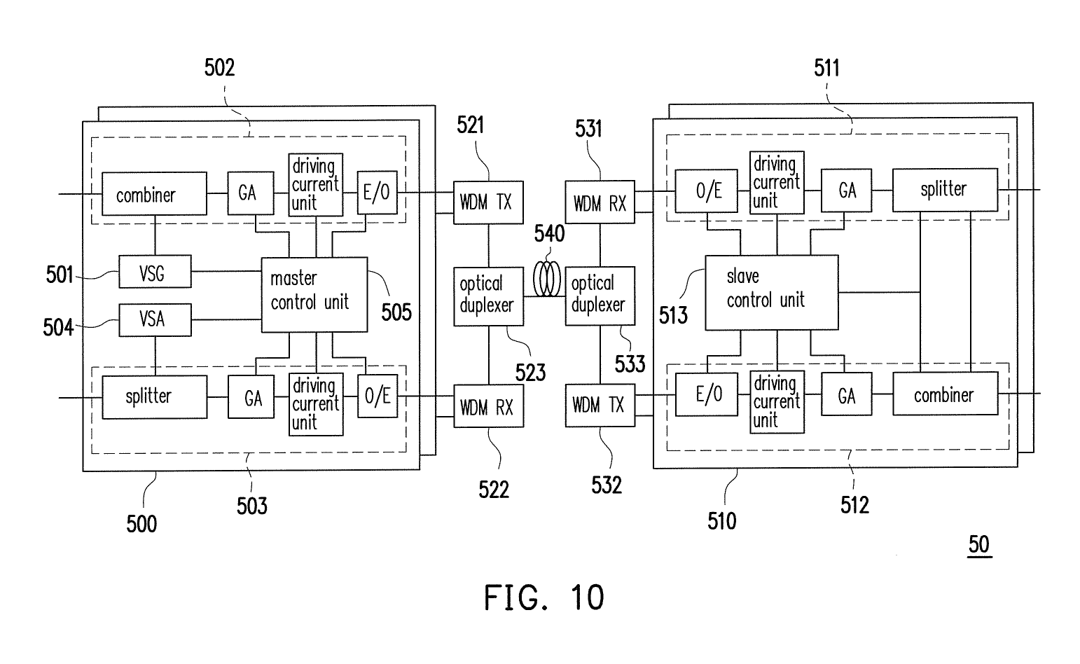

FIG. 10 is a schematic diagram illustrating a self-optimizing optical transmission device according to one of the exemplary embodiments. Compared to the exemplary embodiment shown in FIG. 5, the exemplary embodiment shown in FIG. 10 provides an implementation with more details. For example, the optical downlink signal is being processed in a wavelength division multiplexing transmitter (WDM TX) 521 and an optical duplexer 523 before transmitted through the fiber 540, and the slave O/E 511 would receive the optical downlink signal from fiber 540 after the process of the optical duplexer 533 and the wavelength division multiplexing receiver (WDM RX) 531, and vice versa. Furthermore, the master E/O 502, the master O/E 503, the slave O/E 511 and the slave E/O 512 respectively includes but not limited to a gain adjustment (GA) unit, a driving current unit (or a bias tee unit) and a E/O converting unit (or O/E converting unit), so that the master control unit 505 and the slave control unit 513 could directly control the GA value of the GA unit of the master E/O 502, the master O/E 503, the slave O/E 511 and the slave E/O 512 according to the updated GA value, and control an driving current of the driving current unit of the master E/O 502, the master O/E 503, the slave O/E 511 and the slave E/O 512. In addition, the GA unit may include a plurality of amplifiers and step attenuators that would be configured for adjusting the input/output levels according to the GA values or the updated GA value. By adjusting the driving current of the master E/O 502, the master O/E 503, the slave O/E 511 and the slave E/O 512 and the input/output power level shift between the electric signals (e.g., the integrated analog downlink/uplink signal) and the optical signals (e.g., the optical downlink/uplink signal), input/output levels of the electric signals/optical signals could be fitted in the dynamic range window, so that a minimum EVM value can ensured, and the performance of the master E/O 502, the master O/E 503, the slave O/E 511 and the slave E/O 512 could also be guaranteed thereby.

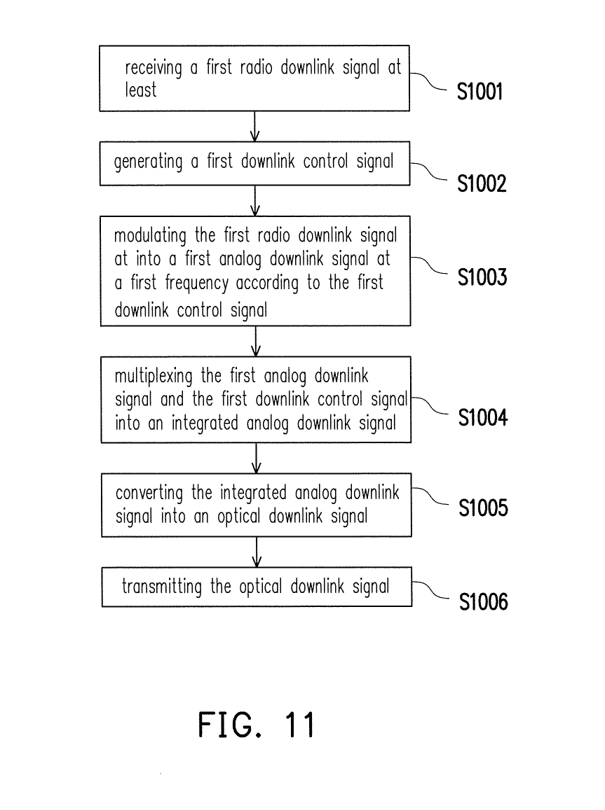

In the present disclosure, a radio frequency signal transceiving method would be configured for a radio equipment controller (REC) of a radio frequency signal transceiving device to exchange radio frequency signals between a plurality of Baseband Units (BBUs) and a plurality of Radio Equipments (RE) that respectively connected to a plurality of Remote Radio Units (RRUs), is also provided. FIG. 11 is a flow chart illustrating radio frequency signal transceiving method according to one of the exemplary embodiments. Referring to FIG. 11, the method would include but not limited to the step of: receiving a first radio downlink signal at least (step S1001), generating a first downlink control signal (step S1002), modulating the first radio downlink signal at least into a first analog downlink signal at a first frequency according to the first downlink control signal (step S1003), multiplexing the first analog downlink signal and the first downlink control signal into an integrated analog downlink signal (step S1004), converting the integrated analog downlink signal into an optical downlink signal (step S1005), and transmitting the optical downlink signal (step S1006). The detailed implementation of the method can be referred to the exemplary embodiments shown in FIG. 1-9, the descriptions would be omitted herein.

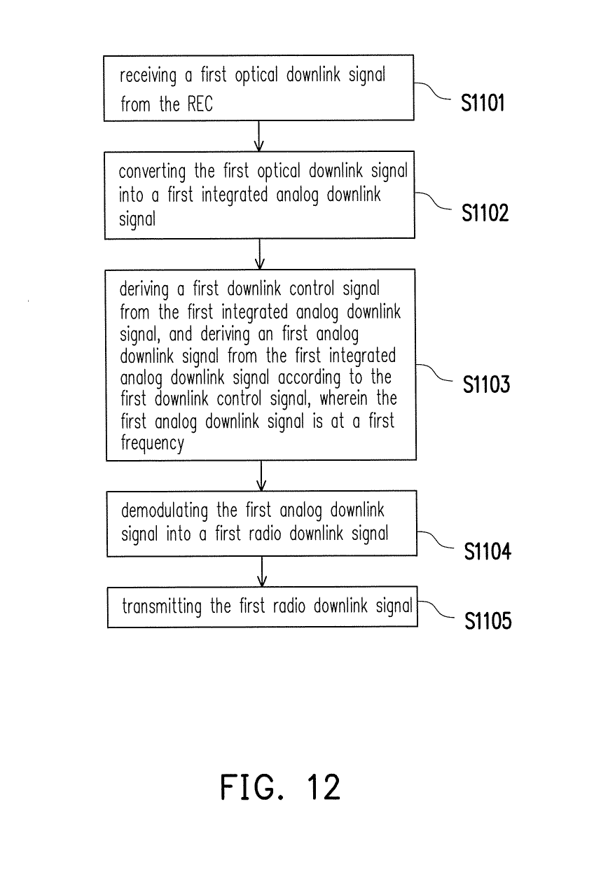

In the present disclosure, a radio frequency signal transceiving method would be configured for a Radio Equipments (RE) of a radio frequency signal transceiving device to exchange radio frequency signals between a radio equipment controller (REC) and a Remote Radio Units (RRU), wherein the REC is connected to a Baseband Units (BBU), is provided. FIG. 12 is a flow chart illustrating radio frequency signal transceiving method according to one of the exemplary embodiments. Referring to FIG. 12, the method would include but not limited to the step of: receiving a first optical downlink signal from the REC (step S1101), converting the first optical downlink signal into a first integrated analog downlink signal (S 1102), deriving a first downlink control signal from the first integrated analog downlink signal, and deriving an first analog downlink signal from the first integrated analog downlink signal according to the first downlink control signal, wherein the first analog downlink signal is at a first frequency (S 1103), demodulating the first analog downlink signal into a first radio downlink signal (S1104), and transmitting the first radio downlink signal (S1105). The detailed implementation of the method can be referred to the exemplary embodiments shown in FIG. 1-9, the descriptions would be omitted herein.

It is noted that, the self-optimizing optical transmission device and method thereof provided in this disclosure could be combined with the radio frequency transceiving device provided in the disclosure (e.g., respectively combines the master control unit 505, the master E/O 502 and the master O/E 503 shown in FIG. 5 with the master control unit 126, the REC E/O 123 and the REC O/E 124, also the slave control unit 513, the slave O/E 511 and the slave E/O 512 shown in FIG. 5 with the slave control unit, the O/E 511 and the E/O in the slave control unit), so that the self-optimizing optical transmission device and method thereof could be used by the radio frequency transceiving device to adjust the link performance. On the other hand, the self-optimizing optical transmission device and method could also be used with other signal transmission device/system that evolves electrical/optical signal conversion apart from the radio frequency transceiving device mentioned above, the disclosure is not limited thereto.

Based on above, in this disclosure, a radio frequency transceiving device and methods thereof are provided. The proposed radio frequency transceiving device may converts the radio signals received from the BBUs or the RRUs into analog intermediate frequency signals at different frequency when exchanging between the REC and the REs, which may greatly improve the bandwidth usage of the optical transmission. for example, For example, the CPRI consumes more than 9 GHz of bandwidth to transmit/receive 24 channels of 3.84 MHz W-CDMA signaling, whereas the proposed device would only need a bandwidth less than 1 GHz to transmit/receive the 24 channels of 3.84 MHz W-CDMA signaling. In addition, and a self-optimizing optical transmission device and method thereof, which may be integrated with a radio frequency transceiving device described above, are also provided. In the proposed device, an EVM value of the optical transmission could be monitoring, and the device could automatically adjust the GA value and the driving current of the E/O (O/E) such that a connection quality of optical transmission is ensured.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A radio frequency signal transceiving method, configured for a radio equipment controller (REC) of a radio frequency signal transceiving device to exchange radio signals between a plurality of Baseband Units (BBUs) and a plurality of Radio Equipments (REs) that respectively connected to a plurality of Remote Radio Units (RRUs), the method comprising:
receiving a first radio downlink signal at least;
generating a first downlink control signal;
modulating the first radio downlink signal at least into a first analog downlink signal at a first frequency according to the first downlink control signal;
multiplexing the first analog downlink signal and the first downlink control signal into an integrated analog downlink signal;
converting the integrated analog downlink signal into a first optical downlink signal; and
transmitting the first optical downlink signal.

2. The radio frequency signal transceiving method according to claim 1, wherein before the step of multiplexing the first analog downlink signal and the first control signal into the integrated analog downlink signal, the radio frequency signal transceiving method further comprising:
receiving a second radio downlink signal;
generating a second downlink control signal;
modulating the second downlink signal into a second analog downlink signal at a second frequency according to the second downlink control signal; and
the step of multiplexing the first analog downlink signal and the first control signal into the integrated analog downlink signal, further comprising:
multiplexing the first analog downlink signal, the first downlink control signal, the second analog downlink signal and the second downlink control signal into the integrated analog downlink signal.

3. The radio frequency signal transceiving method according to claim 1, wherein the method further comprising:
receiving an optical uplink signal;
converting the optical uplink signal into an integrated analog uplink signal;
de-multiplexing the integrated analog uplink signal into a first uplink control signal, a second uplink control signal, a first analog uplink signal at the first frequency and a second analog uplink signal at the second frequency;
respectively demodulating the first analog uplink signal and the second analog uplink signal into a first radio uplink signal and a second radio uplink signal;
respectively analyzing the first uplink control signal and the second uplink control signal; and
transmitting the first radio uplink signal and the second radio uplink signal.

4. A radio frequency signal transceiving method, configured for a first Radio Equipments (RE) of a radio frequency signal transceiving device to exchange radio frequency signals between a Baseband Units (BBU) and a Remote Radio Units (RRU) by a radio equipment controller (REC), wherein the REC is connected to the BBU and the RE is connected to the RRU, the method comprising:
receiving a first optical downlink signal from the REC;
converting the first optical downlink signal into a first integrated analog downlink signal;
deriving a first downlink control signal from the first integrated analog downlink signal, and deriving an first analog downlink signal from the first integrated analog downlink signal according to the first downlink control signal, wherein the first analog downlink signal is at a first frequency;
demodulating the first analog downlink signal into a first radio downlink signal; and
transmitting the first radio downlink signal.

5. The radio frequency signal transceiving method according to claim 4, wherein the method further comprising:
receiving a first radio uplink signal;
modulating the first radio uplink signal into a first analog uplink signal at the first frequency;
generating a first uplink control signal responding to the first downlink control signal;
multiplexing the first analog uplink signal and the first uplink control signal, into a first integrated analog uplink signal;
converting the first integrated analog uplink signal into a first optical uplink signal; and
transmitting the first optical uplink signal to the REC.

6. The radio frequency signal transceiving method according to claim 4, wherein after the step of deriving the first downlink control signal and the first analog downlink signal, the method further comprising:
deriving a second integrated analog downlink signal from the first integrated analog downlink signal;
converting the second integrated analog downlink signal into a second optical downlink signal; and
transmitting the second optical downlink signal to a second RE of the radio frequency signal transceiving device.

7. The radio frequency signal transceiving method according to claim 6, wherein the method further comprising:
receiving a second optical uplink signal from the second RE of the radio frequency signal transceiving device;
converting the second optical uplink signal to a second integrated analog uplink signal;
multiplexing the first analog uplink signal, the first uplink control signal and the second integrated analog uplink signal, into a third integrated analog uplink signal;
converting the third integrated analog uplink signal into a third optical uplink signal; and
transmitting the third optical uplink signal to the REC.

8. The radio frequency signal transceiving method according to claim 4, wherein the first radio downlink signal comprising either of
a digital downlink signal,
an analog downlink signal at a radio frequency accordant with the frequency which the downlink signal transmitting at the RRU, or
an analog downlink control signal at a specified frequency.

9. The radio frequency signal transceiving method according to claim 4, wherein the first radio uplink signal comprising either of
a digital uplink signal,
an analog uplink signal at a radio frequency accordant with the frequency which the uplink signal receiving at the RRU, or
an analog uplink signal at a specified frequency.

10. The radio frequency signal transceiving method according to claim 4, wherein the first downlink control signal and the first uplink control signal to transceiving radio signal between the REC and RE comprising
the first downlink radio signal,
the first uplink radio signal, or
both of the first downlink radio signal and the first uplink radio signal.

11. The radio frequency signal transceiving method according to claim 5, wherein the first downlink control signal and the first uplink control signal comprising the information of the first frequency, and the method further comprising
controlling and monitoring the RRU according to the first downlink control signal and the first uplink control signal;
adjusting a link gain for the first radio downlink signal and the first uplink signal to be equal;
estimating a single trip delay from the REC to the RE according to the first downlink control signal and the first uplink control signal; and
changing a link performance by exchanging the first downlink control signal, the first uplink control signal between the REC with the first RE.

12. A radio frequency signal transceiving device, comprising:
a radio equipment controller (REC);
a plurality of Radio Equipments (REs), connected to the REC, wherein the REs comprising a first RE and a second RE at least,
wherein the REC:
receives a first radio downlink signal at least;
generates a first downlink control signal;
modulates the first radio downlink signal into a first analog downlink signal at a first frequency according to the first downlink control signal;
multiplexes the first analog downlink signal and the first downlink control signal into a first integrated analog downlink signal;
converts the first integrated analog downlink signal into a first optical downlink signal; and
transmits the first optical downlink signal to the REs.

13. The radio frequency signal transceiving device according to claim 12, wherein:
the REC:
further receives a second radio downlink signal;
generates a second downlink control signal;
modulates the second radio downlink signal into a second analog downlink signal at a second frequency according to the second downlink control signal; and
multiplexes the first analog downlink signal, the first downlink control signal a second downlink control signal according to the second analog downlink signal into the first integrated analog downlink signal.

14. The radio frequency signal transceiving device according to claim 13,
wherein the REC:
receives a first optical uplink signal;
converts the first optical uplink signal into a first integrated analog uplink signal;
de-multiplexes the first integrated analog uplink signal into a first uplink control signal, a second uplink control signal, a first analog uplink signal at the first frequency and a second analog uplink signal at the second frequency;
respectively analyzes the first uplink control signal and the second uplink control signal;
respectively demodulates the first analog uplink signal and the second analog uplink signal into a first radio uplink signal and a second radio uplink signal according to the first uplink control signal and the second uplink control signal; and
transmits the first radio uplink signal and the second radio uplink signal.

15. The radio frequency signal transceiving device according to claim 12,
wherein the first RE:
receives a first optical downlink signal from the REC;
converts the first optical downlink signal into a first integrated analog downlink signal;
derives a first analog downlink signal, a first downlink control signal and a second integrated analog downlink signal from the first integrated analog downlink signal, wherein the first analog downlink signal is at the first frequency;
demodulates the first analog downlink signal into the first radio downlink signal;
transmits the first radio downlink signal;
converts the second integrated analog downlink signal into a second optical downlink signal; and
transmits the second optical downlink signal to a second RE of the REs.

16. The radio frequency signal transceiving device according to claim 15, wherein:
the first RE comprising:
a first optical to electric converter (O/E), coupled to the REC, receives the first optical downlink signal, and converts the first optical downlink signal into the first integrated analog downlink signal; and
a first radio front end circuit, coupled to the first O/E, derives the first analog downlink signal, the first downlink control signal, and the second integrated analog downlink signal from the integrated analog downlink signal, demodulates the first analog downlink signal into the first radio downlink signal, and transmits the first radio downlink signal; and
a first electric to optical converter (E/O), coupled to the first radio front end circuit, converts the second integrated analog downlink signal into the second optical downlink signal, transmits the second optical downlink signal to the second RE of the REs.

17. The radio frequency signal transceiving device according to claim 16, wherein:
the second RE comprising:
a second optical to electric converter (O/E), coupled to the first E/O of the first RE, receives the second optical downlink signal from the first RE, and converts the second optical downlink signal into the third integrated analog downlink signal; and
a second radio front end circuit, coupled to the second O/E, derives the second analog downlink signal and the second downlink control signal from the third integrated analog downlink signal, demodulates the second analog downlink signal into the second radio downlink signal, and transmits the second radio downlink signal.

18. The radio frequency signal transceiving device according to claim 15,
wherein the first RE:
receives a first radio uplink signal;
modulates the first radio uplink signal into a first analog uplink signal at the first frequency;
generates a first uplink control signal responding to the first downlink control signal;
receives a second optical uplink signal from the second RE of the REs;
converts the second optical uplink signal to a first integrated analog uplink signal;
multiplexes the first analog uplink signal, the first uplink control signal, and the first integrated analog uplink signal into a second integrated analog uplink signal;
converts the second integrated analog uplink signal into the first optical uplink signal; and
transmits the first optical uplink signal to the REC.

19. The radio frequency signal transceiving device according to claim 18, wherein:
when the first radio front end circuit receives the first radio uplink signal, the first uplink control signal, and the first integrated analog uplink signal, the first radio front end circuit modulates the first radio uplink signal into the first analog uplink signal at the first frequency, multiplexes the first analog uplink signal, the first uplink control signal, and the first integrated analog uplink signal into the second integrated analog uplink signal, and the first RE further comprising:
a third O/E, coupled to the second E/O of the second RE, receives and converts the second optical uplink signal into the first integrated analog uplink signal; and
a second E/O, coupled to the first radio front end circuit and the REC, converts the second integrated analog uplink signal into the first optical uplink signal, and transmits the first optical uplink signal to the REC.

20. The radio frequency signal transceiving device according to claim 18,
wherein the second RE:
receives the second optical downlink signal from the first RE;
converts the second optical downlink signal into a third integrated analog downlink signal;
derives a second analog downlink signal and a second downlink control signal from the third integrated analog downlink signal, wherein the second analog downlink signal is at a second frequency;
demodulates the second analog downlink signal into the second radio downlink signal; and
transmits the second radio downlink signal.

21. The radio frequency signal transceiving device according to claim 20,
wherein the second RE:
receives a second radio uplink signal;
modulates the second radio uplink signal into a second analog uplink signal at the second frequency;
generates a second uplink control signal responding to the second downlink control signal;
multiplexes the second analog uplink signal and the second uplink control signal into the first integrated analog uplink signal;
converts the first integrated analog uplink signal into the second optical uplink signal; and
transmits the second optical uplink signal.

22. The radio frequency signal transceiving device according to claim 21, wherein:
when the second radio front end circuit receives the second radio uplink signal and the second uplink control signal, the second radio front end circuit modulates the second radio uplink signal into the second analog uplink signal at the second frequency, and the second RE further comprising:
a third electric-to-optical converter (E/O), coupled to the second radio front end circuit, converts second analog uplink signal into the optical uplink signal.

23. The radio frequency signal transceiving device according to claim 13, wherein the REC comprising:
a first front end circuit, receives the first radio downlink signal and the first downlink control signal, modulates the first radio downlink signal into the first analog downlink signal at the first frequency;
a second front end circuit, receives the second radio downlink signal and the first downlink control signal, modulates the second radio downlink signal into the second analog downlink signal at the second frequency;
a master control unit, coupled to the first front end circuit and the second front end circuit, assigns the frequency value of the first frequency and the second frequency, analyzes the first uplink control signal and the second uplink control signal, generates the first downlink control signal and the downlink second control signal at a control frequency at least, and transmits the first downlink control signal and the second downlink control signal;
a multiplexer, coupled to the first front end circuit, the second front end circuit and the master control unit, multiplexes the first analog downlink signal, the second analog downlink signal, the first downlink control signal and the second downlink control signal into the first integrated analog downlink signal; and
an REC electric to optical converter (E/O), coupled to the multiplexer, converts the first integrated analog downlink signal into the first optical downlink signal, and transmits the first optical downlink signal to the REs.

24. The radio frequency signal transceiving device according to claim 18, wherein the REC further comprising:
an REC optical to electronic converter (O/E), receives the first optical uplink signal, and converts the first optical uplink signal into the first integrated analog uplink signal;
a de-multiplexer, coupled to the REC O/E and the first front end circuit and the second front end circuit, de-multiplexes the first integrated analog uplink signal into the first analog uplink signal at the first frequency and the second analog uplink signal at the second frequency, and respectively transmits the first analog uplink signal and the second analog uplink signal to the first front end circuit and the second front end circuit,
wherein the first front end circuit demodulates the first analog uplink signal into a first radio uplink signal when receiving the first analog uplink signal, and transmits the first radio uplink signal; and
the second front end circuit demodulates the second analog uplink signal into a second radio uplink signal when receiving the second analog uplink signal, and transmits the second radio uplink signal.

25. The radio frequency signal transceiving device according to claim 22, wherein:
the first RE further comprising:
a first slave control unit, coupled to the first radio front end circuit, extracts the first downlink control signal from the first integrated analog downlink signal, generates a first control message according to the first downlink control signal, and transmits the first control message to the first radio front end circuit, wherein the first radio front end circuit derives the first analog downlink signal, the first downlink control signal, and the second integrated analog downlink signal from first integrated analog downlink signal according to the first control message; and
the second RE further comprising:
a second slave control unit, coupled to the second radio front end circuit, extracts the second downlink control signal from the third integrated analog downlink signals, generates a second control message according to the second control signal, and transmits the second control message to the second radio front end circuit, wherein the second radio front end circuit derives the second analog downlink signal and the second downlink control signal from third integrated analog downlink signal according to the second control message.

26. The radio frequency signal transceiving device according to claim 25 wherein:
the first slave control unit:
generates a first uplink control signal responding to the first downlink control signal;
adjust a link gain for the first radio downlink signal and the first uplink signal to be equal;
the second slave control unit:
generates a second uplink control signal responding to the second downlink control signal;
adjust the link gain for the second radio downlink signal and the second uplink signal to be equal; and
the master control unit:
controls and monitors the RRUs according to the first downlink control signal, the second downlink control signal, the first uplink control signal and the second uplink control signal; and
estimates the round trip delay from the REC to one of the REs; and
changes a link performance by exchanging the first downlink control signal, the first uplink control signal, the second downlink control signal and the second uplink control signal between the REC with the first RE and second RE at least, wherein the link performance comprising a dynamic range.

27. A self-optimizing optical transmission method configured for an optical transmission device to self monitor and self adjustment, comprising:
generating a testing signal at a master end;
combining the testing signal into an integrated analog downlink signal and converting the integrated analog downlink signal into the optical downlink signal at the master end;
converting the optical downlink signal to the integrated analog downlink signal, deriving the testing signal from the integrated analog downlink signal, combining the testing signal into an integrated analog uplink signal, and converting the integrated analog uplink signal into an optical uplink signal at a slave end;
receiving the optical uplink signal at the master end;
converting the optical uplink signal to the integrated analog uplink signal, and splitting the testing signal from the integrated analog uplink signal at the master end;
analyzing the testing signal to generate a testing result, wherein the testing result comprising a error vector magnitude (EVM) value; and
adjusting an input level and a driving current of a plurality of E/Os and output levels and driving currents of O/Es at the master end and the slave end via generating a master control signal and a slave control signal according to the testing result.

28. The self-optimizing optical transmission method according to claim 27, wherein:
the test signal comprising a radio downlink signal; and
wherein the step of combining the testing signal into the integrated analog uplink signal comprising:
combining the testing signal into the integrated analog uplink signal by switching or coupling.

29. The self-optimizing optical transmission method according to claim 28, the method further comprising:
periodically generating the testing signal, in order to derives the EVM value;
when the EVM value is bigger than a magnitude threshold, performing a self-diagnose process to get a plurality of updated EVM values corresponding to a plurality of generated gain adjustment (GA) values and a plurality of the driving currents; and
if the updated EVM value is smaller than the threshold, storing the corresponding GA values and the corresponding driving currents, and adjusting the input levels and the driving currents of the E/Os and the output levels and the driving currents of the O/Es via the master control signal and the slave control signal according to the corresponding GA value and the corresponding driving current; and
if the updated EVM value is bigger than the threshold, performing an alarm process.

30. The self-optimizing optical transmission method according to claim 29, wherein the self-diagnose process comprising:
setting a set of GA candidates and a set of driving currents candidates;
adjusting the driving currents of the E/Os and the O/Es at the master end and the slave end both via the master control signal and the slave control signal according to the set of driving currents candidates;
adjusting the input levels of the E/Os and the output levels of the O/Es at the master end and the slave end both via the master control signal and the slave control signal according to the set of GA candidates;
generating the testing signal when the input levels and the driving currents of the E/Os and the output levels and the driving currents of the O/Es at the master end and the slave end being adjusted;
analyzing the testing results of the testing signals corresponding to the set of GA candidates and the set of driving current candidates, and choosing the driving current candidate that corresponds to a maximum dynamic range as an updated driving current and setting an updated GA value to adjust the input level of the E/Os and the output level of the O/Esat the master end and the slave end to meet the maximum dynamic range;
setting the driving currents of the E/Os and the O/Es at the master end and the slave end both via the master control signal and the slave control signal according to the updated driving current; and
setting the input levels of the E/Os and the output levels of the O/Es at the master end and the slave end both via the master control signal and the slave control signal according to the updated GA value,
wherein the dynamic range comprising a maximum input level and a minimum input level of the EVM value less than the threshold for the driving current.

31. A self-optimizing optical transmission device, configured for self-monitoring and self-adjustment, comprising a master end and a slave end:
wherein the master end, comprising:
a vector signal generator, generates a testing signal;
a master electric-to-optical converter (E/O), coupled to the VSG, combines the testing signal into an integrated analog downlink signal and converts the integrated analog downlink signal into the optical downlink signal a master optical-to-electric converter (O/E), receives an optical uplink signal, converts the optical uplink signal to an integrated analog uplink signal, and splits the testing signal from the integrated analog uplink signal; and
a vector signal analyzer (VSA), coupled to the master O/E, analyzes the testing signal to generate a testing result, wherein the testing result comprising a error vector magnitude (EVM) value;
a master control unit, coupled to the master E/O, the master O/E, the VSG and the VSA, receives the testing result, and adjusts an input level and a driving current of the master E/O and an output level and a driving current of the master O/E via generating a master control signal according to the testing result; and
wherein the slave end comprising:
a slave O/E, coupled to the master E/O, receives and converts the optical downlink signal into the integrated analog downlink signal;
a slave E/O, coupled to the slave O/E, converts the integrated analog uplink signal into the optical uplink signal;
a splitter, coupled to the slave O/E, splits the testing signal from the integrated analog downlink signal;
a combiner, coupled to the slave E/O; combines the testing signal into the integrated analog uplink signal; and
a slave control unit, coupled to the slave O/E, the slave E/O, the splitter, and the combiner, adjusts the input level and the driving current of the slave E/O and the output level and the driving current of the slave O/E by a gain adjustment (GA) value via the master control signal and a slave control signal exchanging between the master control unit and the slave control unit according to the testing result.

32. The self-optimizing optical transmission device according to claim 31, wherein:
the O/E further comprising a driving current circuit and a GA unit; and
the E/O further comprising a driving current circuit and a GA unit; and
the GA unit further comprising a plurality of amplifiers and a plurality of step attenuators, wherein the amplifiers and the step attenuators are configured to adjust input levels of the E/Os and the output levels of the O/Es.

33. The self-optimizing optical transmission device according to claim 31, wherein:
the master control unit periodically controls the VSG to generate the testing signal, in order to derive the EVM value;
when the EVM value is bigger than a magnitude threshold, the master control unit performs a self-diagnose process to get a plurality of updated GA values, a plurality of driving currents;
if the updated EVM value is smaller than the magnitude threshold, the master control unit stores the corresponding GA values and corresponding driving currents, and the master control unit adjusts the input levels and the driving currents of the E/Os and the output levels and the driving currents of the O/Es via the master control signal and the slave control signal according to the corresponding GA values and the corresponding driving currents.

34. The self-optimizing optical transmission device according to claim 33, wherein:
if the updated EVM value is bigger than the magnitude threshold, the master control unit performs an alarm process.

35. The self-optimizing optical transmission device according to claim 34, wherein the self-diagnose process comprising:
setting a set of GA candidates and a set of driving currents candidates;
adjusting the driving currents of the E/Os and the O/Es at the master end and the slave end both via the master control signal and the slave control signal according to the set of driving currents candidates;
adjusting the input levels of the E/Os and the output levels of the O/Es at the master end and the slave end both via the master control signal and the slave control signal according to the set of GA candidates;
controlling the VSG to generate testing signal when the input levels and the driving currents of the E/Os and the output levels and the driving currents of the O/Es at the master end and the slave end being adjusted;
analyzing the testing results of the testing signals corresponding to the set of GA candidates and the set of driving current candidates, and choosing the driving current candidate that corresponds to the maximum dynamic range as an updated driving current and setting an updated GA value to adjust the input level of the E/Os and the output level of the O/Es at the master end and the slave end to meet the maximum dynamic range;
setting the driving currents of the E/Os and the O/Es at the master end and the slave end both via the master control signal and the slave control signal according to the updated driving current; and
setting the input levels of the E/Os and the output levels of the O/Es at the master end and the slave end both via the master control signal and the slave control signal according to the updated GA value.
